(19) United States
(12) Patent Application Publication
(10) Pub. No.: US 2026/0179041 A1
(43) Pub. Date: Jun. 25, 2026

(54) WORK ANALYSIS SYSTEM AND WORK ANALYSIS METHOD

(71) Applicant: Hitachi High-Tech Corporation, Minato-ku, Tokyo (JP)

(72) Inventors: Naohito IKEDA, Tokyo (JP); Takashi NUMATA, Tokyo (JP); Katsutoshi MURAMATSU, Tokyo (JP); Kohei SATO, Tokyo (JP)

(21) Appl. No.: 18/846,922

(22) PCT Filed: Sep. 8, 2023
(86) PCT No.: PCT/JP2023/032866

§ 371 Date: Sep. 13, 2024

(51) Int. Cl. G06Q 10/10; G06Q 10/06; G06Q 10/0631; G06Q 10/0633

(52) U.S. Cl. CPC G06Q 10/10; G06Q 10/06; G06Q 10/06311; G06Q 10/063112; G06Q 10/06316; G06Q 10/0633

(57) ABSTRACT

A work analysis system includes: a work measurement unit 210 configured to collect measurement data from a sensor that measures an operation of a worker in a predetermined work; a measurement data accumulation unit 120 configured to accumulate the measurement data collected by the work measurement unit; and a measurement data analysis unit 220 configured to analyze the predetermined work based on the measurement data accumulated in the measurement data accumulation unit, and the measurement data analysis unit includes a workability evaluation unit 221 configured to evaluate workability of the predetermined work based on the measurement data accumulated in the measurement data accumulation unit, and a work improvement approach determination unit 222 configured to determine a work improvement approach of the predetermined work based on the workability of the predetermined work evaluated by the workability evaluation unit.

### TECHNICAL FIELD

The present invention relates to a work analysis system and a work analysis method.

### BACKGROUND ART

In order to improve productivity of a semiconductor device, a semiconductor manufacturing device is required not only to improve performance thereof, but also to improve an operating rate through more efficient maintenance. Much of the maintenance of the semiconductor manufacturing device involves a manual work. As the shortage of personnel and skilled worker continues to increase, improving the efficiency of maintenance is an important issue.

PTL 1 discloses a learning support system that enables efficient learning of a technique. The learning support system includes a display unit that is worn by a learner, an imaging unit that is worn by the learner and captures a view image of the learner, and a storage unit that stores a model video which is a video of a work operation of an instructor serving as a model of an operation of the learner, the model video is superimposed on the view image captured by the imaging unit and displayed on the display unit, and a display content of the model video is dynamically changed according to characteristics of the work operation of the learner in the view image.

### CITATION LIST

### Patent Literature

PTL 1: JP2020-144233A

### SUMMARY OF INVENTION

### Technical Problem

As disclosed in PTL 1, many ideas are being considered for using a sensor to monitor a manual work and support a work. While these ideas are expected to improve efficiency of the manual work, the ideas are based on the premise that the work is performed manually, and improvement cannot be made beyond limits of human ability.

In order to respond to the shortage of personnel and skilled worker, which will further develop in the future, it is essential to review a current work or a structure of a device (product) targeting the work from the perspective of whether the work is necessary in the first place, or whether it is appropriate to perform the work manually, and to aim for overall optimization. An object of the invention is to provide a work analysis system and a work analysis method that provide a viewpoint for improving a work based on monitoring data of the work by a sensor.

### Solution to Problem

A work analysis system according to one embodiment of the invention includes: a work measurement unit configured to collect measurement data from a sensor that measures an operation of a worker in a predetermined work; a measurement data accumulation unit configured to accumulate the measurement data collected by the work measurement unit; and a measurement data analysis unit configured to analyze the predetermined work based on the measurement data accumulated in the measurement data accumulation unit, and the measurement data analysis unit includes a workability evaluation unit configured to evaluate workability of the predetermined work based on the measurement data accumulated in the measurement data accumulation unit, and a work improvement approach determination unit configured to determine a work improvement approach of the predetermined work based on the workability of the predetermined work evaluated by the workability evaluation unit.

### Advantageous Effects of Invention

Provided is a work analysis system and a work analysis method that provide a viewpoint for improving a work based on monitoring data of the work by a sensor. Other problems and novel features will become apparent from description of the present specification and the accompanying drawings.

### BRIEF DESCRIPTION OF DRAWINGS

FIG. 1 is a schematic configuration diagram of a work analysis system.

FIG. 2A is a hardware configuration of an information processing device.

FIG. 2B is a functional block diagram of the work analysis system.

FIG. 3 is a flowchart of a maintenance work of a semiconductor manufacturing device.

FIG. 4 is a diagram illustrating a work performed in each process of the maintenance work.

FIG. 5A is an example of a complexity evaluation of a device disassembling process.

FIG. 5B is an example of a complexity evaluation of a maintenance process.

FIG. 6 is an example of a work easiness evaluation table.

FIG. 7 is a histogram of a work time.

FIG. 8A is an example of a dexterity evaluation of the device disassembling process.

FIG. 8B is an example of a dexterity evaluation of the maintenance process.

FIG. 9 is a determination flow of a work improvement approach.

FIG. 10 is an example of a work element conversion table.

FIG. 11 is an automation proposal creation flow of a process.

FIG. 12 is an example of a machine function conversion table.

FIG. 13 is an example of a work analysis report display screen.

### DESCRIPTION OF EMBODIMENTS

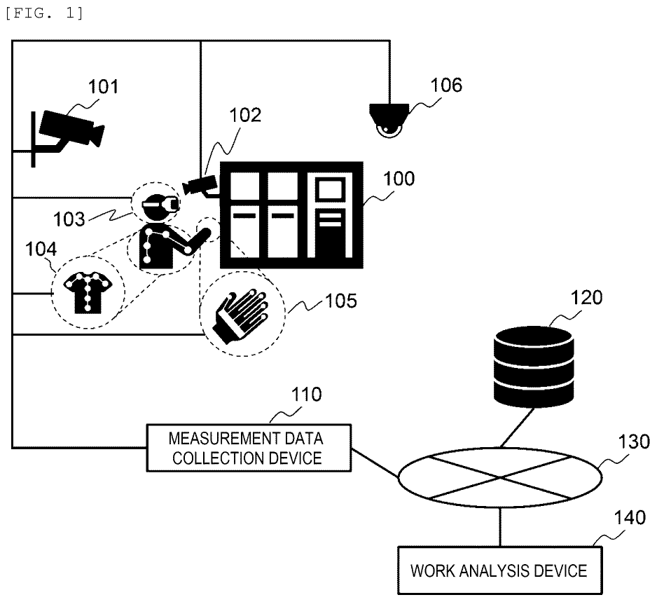

FIG. 1 is a schematic configuration diagram of a work analysis system. Here, a maintenance work performed by a worker on a semiconductor manufacturing device 100 is used as an example, a process of monitoring the work of the worker, analyzing the work, and proposing improvement will be described using the work analysis system according to this embodiment. The work analysis system includes sensor groups 101 to 106 that monitor the work of the worker with respect to the semiconductor manufacturing device 100, a measurement data collection device 110 that collects measurement data related to an operation of the worker during the work, the measurement data being detected by the sensor groups 101 to 106, a measurement data accumulation unit 120 that accumulates the measurement data collected by the measurement data collection device 110, and a work analysis device 140 that analyzes the work and proposals improvement based on the measurement data accumulated in the measurement data accumulation unit 120. The measurement data collection device 110, the measurement data accumulation unit 120, and the work analysis device 140 are communicably connected to one another via a network 130. The network 130 may be wired or wireless, and a communication standard may be optional.

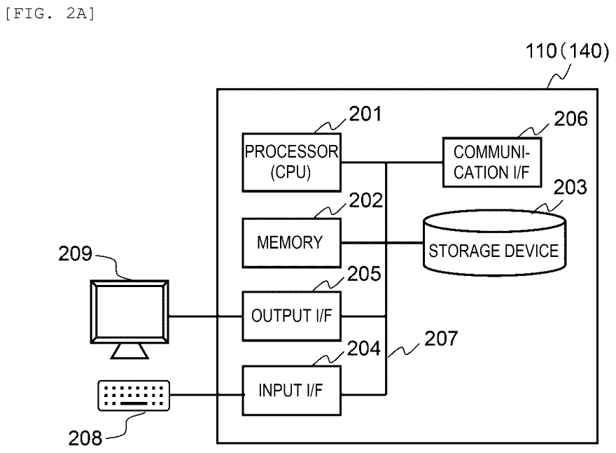

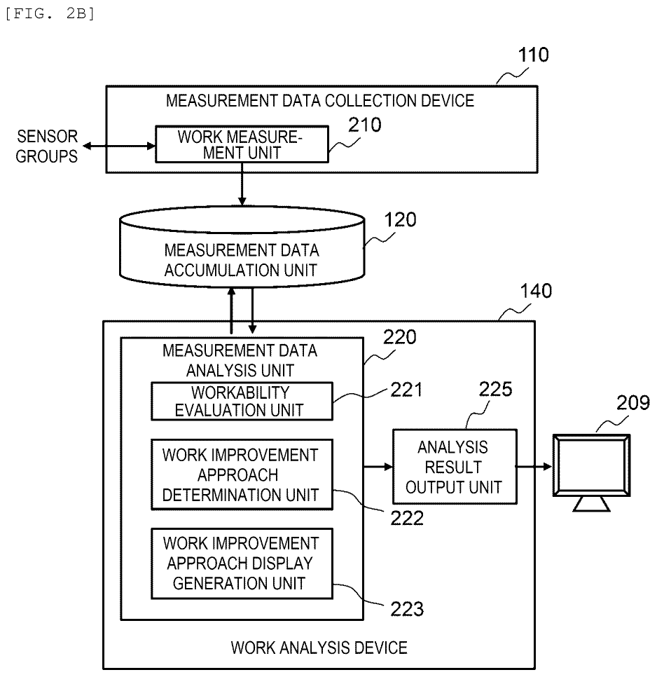

FIG. 2A shows a hardware configuration of the measurement data collection device 110 and the work analysis device 140. These are implemented by an information processing device including a processor (CPU) 201, a memory 202, a storage device 203, an input interface (I/F) 204, an output I/F 205, a communication I/F 206, and a bus 207 as main components as shown in FIG. 2A. The processor 201 functions as a functional unit (functional block) that provides a predetermined function by executing processing according to a program loaded in the memory 202. The storage device 203 stores data and a program used by the functional unit. As the storage device 203, for example, a nonvolatile storage medium such as a hard disk drive (HDD) or a solid state drive (SSD) is used. The input I/F 204 is an interface for connecting an input device 208 such as a keyboard and a pointing device, and the output I/F 205 is an interface for connecting a display device 209. The communication I/F 206 enables communication with another information processing device via the network 130. These components are communicably connected to one another via the bus 207.

Each of the measurement data collection device 110 and the work analysis device 140 is not required to be implemented by an individual information processing device, but may be implemented on one information processing device, and the measurement data may be accumulated in the storage device 203. In this case, the storage device 203 functions as the measurement data accumulation unit 120. Some or all of functions of the measurement data collection device 110 and the work analysis device 140 may be implemented as applications on a cloud.

FIG. 2B shows a functional block diagram of the work analysis system. A work measurement unit 210 of the measurement data collection device 110 controls the sensor groups and accumulates the measurement data in the measurement data accumulation unit 120. As shown in FIG. 1, the sensor groups include a camera 101 that captures an image of a work of a worker in an overhead view, an device installation type camera 102, a head mounted display (HMD) 103, a worn work sensor 104 worn by a worker, a glove type sensor 105, a 360° camera 106 that captures an image of an entire work area, and the like. However, the sensor groups shown in FIG. 1 are an example, and sensors other than those shown in the example may be used, and the sensors shown in the example are not required to be used. The work measurement unit 210 monitors a situation of the work performed by the worker using the sensors. Accordingly, for example, RGB (color) data (video data) from the camera, distance measurement data indicating distance information to a target in addition to the video data if an RGBD camera is used as a camera, which is a sensor capable of acquiring a distance to an object in addition to the RGB data, motion data of a line of sight of a worker from HMD 103, motion data of a skeleton of the worker from the worn work sensor 104, motion data of a finger of the worker from the glove type sensor 105, and the like are accumulated in the measurement data accumulation unit 120 as the measurement data. It is desirable that all the measurement data accumulated in the measurement data accumulation unit 120 be recorded with a time stamp (time information) based on the same reference time. Accordingly, when the work analysis device 140 analyzes the measurement data, the work can be analyzed by integrating the measurement data from the plurality of sensors.

A measurement data analysis unit 220 of the work analysis device 140 analyzes the work using the measurement data accumulated in the measurement data accumulation unit 120. A work analysis result of the measurement data analysis unit 220 is displayed on the display device 209 of the work analysis device 140 by an analysis result output unit 225. Processing of the measurement data analysis unit 220 will be described later with reference to a specific example.

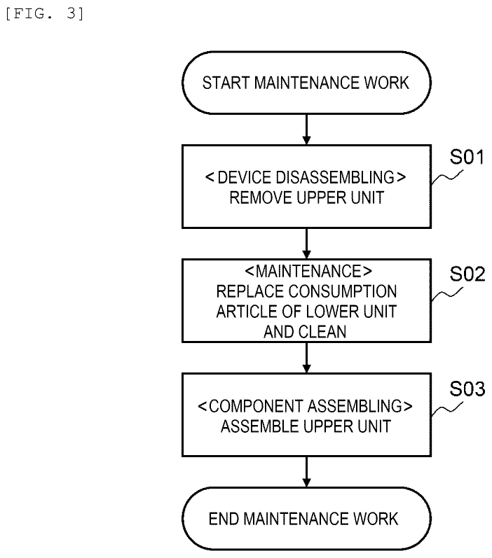

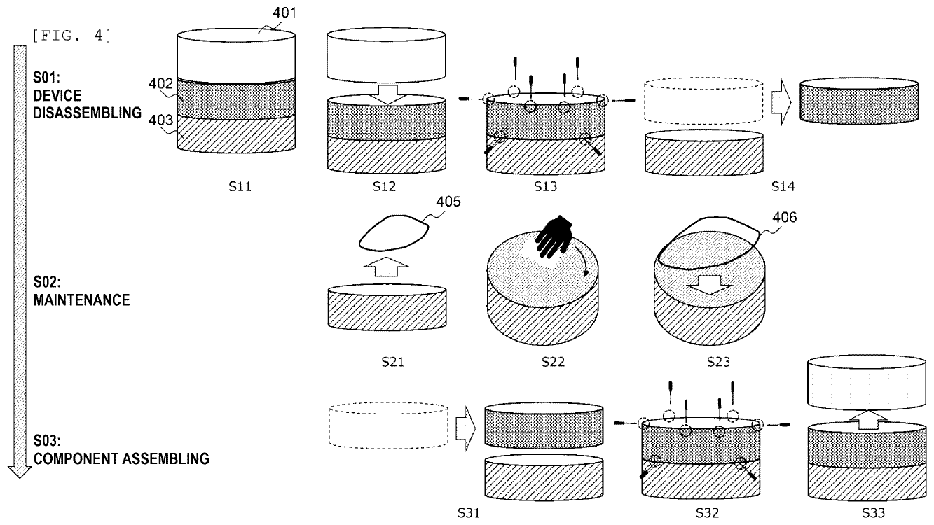

First, the maintenance work of the semiconductor manufacturing device as a specific example will be described with reference to FIGS. 3 and 4. The maintenance work is a work example in which the semiconductor manufacturing device is disassembled, maintenance is performed on target units, and the components are reassembled and returned to a working state. As shown in FIG. 3, the maintenance work mainly includes three processes, that is, device disassembling (S01), maintenance of the target units (S02), and component assembling (S03). This specific example is provided to specifically illustrate the processing in this embodiment, and an analysis target of the work analysis system and a work analysis method in this embodiment is not limited to this example.

A work performed in each process will be described with reference to FIG. 4. In FIG. 4, the semiconductor manufacturing device is schematically shown as including a main body 401, an upper unit 402, and a lower unit 403. For example, when the semiconductor manufacturing device is a plasma processing device, the upper unit 402 is a cavity chamber in which plasma is generated, and the lower unit 403 is a vacuum container in which a sample to be processed is placed. In this specific example, a maintenance location is the lower unit 403.

The device disassembling process (S01) corresponds to states S11 to S14. The state S11 is a state at the start of the work, and the state S12 is a state in which the upper unit 402 and the lower unit 403 connected to each other are separated from the main body 401. The state S13 shows a state in which, in order to separate the upper unit 402 from the lower unit 403, a work of manually removing screws using tools such as drivers is being performed. The state S14 is a state in which the upper unit 402 is separated from the lower unit 403 and a work is performed on the lower unit 403.

The maintenance process (S02) corresponds to states S21 to S23. The state S21 indicates a state in which a work of removing an O-ring 405, which is a consumption article is performed, and the O-ring 405 has been removed from the lower unit 403. The state S22 indicates a state in which a work of wiping deposits and dirt on the lower unit 403 is being performed as cleaning of the lower unit 403. The state S23 indicates a state of a work in which the consumption article is replaced and a new O-ring 406 is attached.

The component assembling process (S03) corresponds to states S31 to S33. In the state S31, the separated upper unit 402 is aligned with the lower unit 403, and the screws are tightened to connect the upper unit 402 and the lower unit 403 in the state S32. In the state S33, the upper unit 402 and the lower unit 403 which are connected are assembled to the main body 401, and thus the assembling work is ended.

Analysis of the measurement data performed by the measurement data analysis unit 220 will be described using the maintenance work described above as an example. The measurement data analysis unit 220 includes a workability evaluation unit 221, a work improvement approach determination unit 222, and a work improvement approach display generation unit 223 (see FIG. 2B). First, the workability evaluation unit 221 evaluates workability using the measurement data.

The workability evaluation unit 221 evaluates the work from the viewpoint of complexity and dexterity. In order to ensure the objectivity of the evaluation, in the evaluation, the collected measurement data is used for quantitatively calculate an evaluation value according to predetermined indicators. Here, the complexity of the work means a degree of complexity of the work performed by the worker, and is indexed by, for example, the number of work elements that constitute the work, work easiness that represents the ease of performing the work elements, and a length of a work time. On the other hand, the dexterity of the work means an experience level and a degree of knowledge required for the worker to perform the work. Specifically, a work in which there is almost no difference in work efficiency or work quality between skilled and unskilled workers is evaluated as a work having low dexterity, and a work in which there is a large difference in work efficiency or work quality between skilled and unskilled workers is evaluated as a work having high dexterity. The dexterity is indexed by, for example, a variation (dispersion) in work time among workers, a variation in operation during a work between skilled and unskilled workers, a content rate of work elements that are evaluated as having high dexterity, and a work success rate.

For both the complexity evaluation and the dexterity evaluation of the work, it is desirable to monitor works performed by many workers many times and accumulate the measurement data for the work to be analyzed. This is because the more the measurement data is accumulated, the more accurate and reliable the evaluation can be statistically.

First, the workability evaluation unit 221 executes preprocessing to divide the measurement data into process units. For example, in this example, the measurement data is divided into three processes, that is, the device disassembling process S01, the maintenance process S02, and the component assembling process S03. The division may be performed by performing video analysis on video data obtained by taking a situation of the work, recognizing a characteristic object or work, and specifying a timing at which the process is divided. For example, a timing at which the upper unit 402 and the lower unit 403 are separated from each other is captured by image recognition, and a time stamp of the video data at that time can be set as a division timing of the device disassembling process S01 and the maintenance process S02. Further, a timing at which a hand of the worker is separated from the O-ring 406 attached to the lower unit 403 is captured by the image recognition, and a time stamp of the video data at that time can be set as a division timing of the maintenance process S02 and the component assembling process S03. Other measurement data acquired simultaneously with the video data can also be divided into process units based on time stamps. How much of the measurement data is divided as one process can be set freely, but for example, it is considered that the works that are grouped into a set in a work manual are divided into one process. Next, the work is evaluated based on the measurement data divided for each process using the time stamp as a reference.

First, the complexity evaluation of the work will be described. In the complexity evaluation, the process is further disassembled into the work elements, the measurement data divided for each process is further disassembled into measurement data for each work element, and the complexity is evaluated. This disassemble into the work elements can also be performed in the same manner as the process division described above.

Here, the work element is defined in advance in a work easiness evaluation table shown in FIG. 6 as a work having a final granularity for evaluating easiness of the work. In the work easiness evaluation table, work elements are categorized according to ease of the work and evaluation values are assigned. For example, downward movement in which a component is moved from an upper side to a lower side is an operation in which a work is easily performed due to gravity, and is evaluated as A (easy) as an evaluation value. On the other hand, lateral movement or upward movement is an operation in which a work is more difficult to perform, and is evaluated as B (normal). Work elements illustrated in FIG. 6 is a very small part, and are created comprehensively so that any work in the maintenance work on the semiconductor manufacturing device falls into one of the work elements.

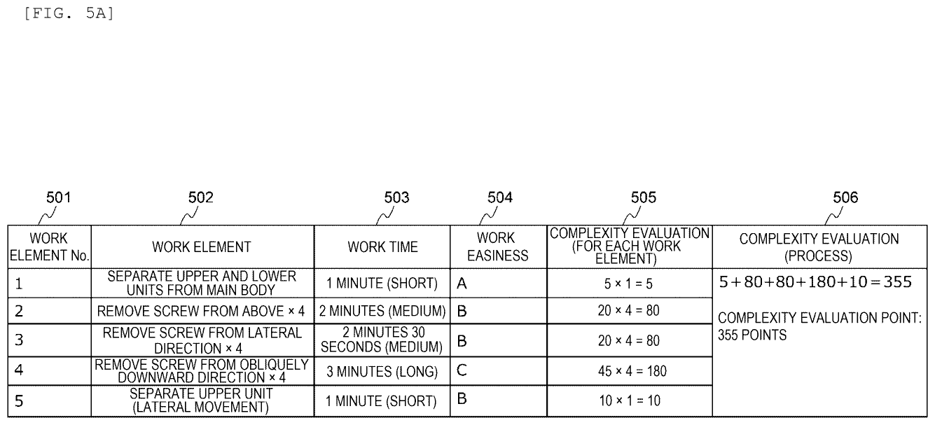

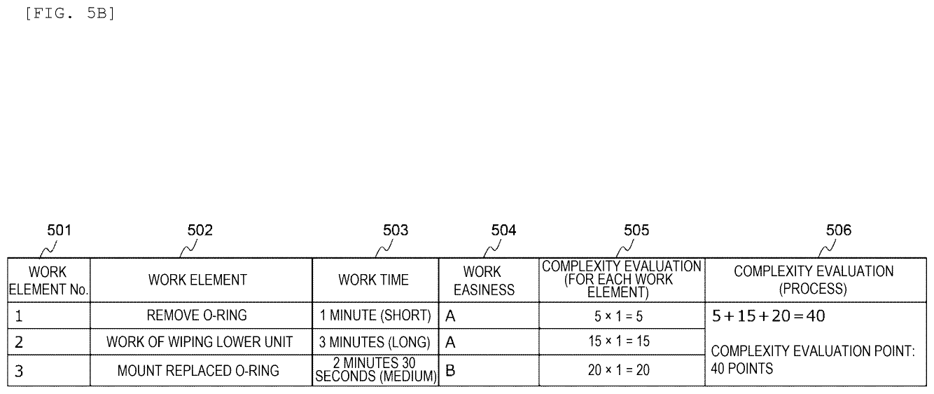

The complexity evaluation of the device disassembling process S01 is shown in FIG. 5A. A work element number 501 is a number that specifies the work element in the process to be analyzed, and a work element 502 indicates a content of the work element in the process. A work time 503 is a work time required to execute the work element, and is measured from the measurement data. When a plurality of work elements are executed in the process, an average time is shown, for example. Work easiness 504 indicates the evaluation value assigned to the work element in the work easiness evaluation table. For example, A means easy, B means normal, and C means difficult. A complexity evaluation (for each work element) 505 indicates a complexity evaluation point for each work element, and a complexity evaluation (process) 506 indicates a complexity evaluation point of the entire process.

The complexity evaluation point for each work element is quantitatively calculated using the work time and the work easiness as indexes. Here, the work time is classified as short, medium, and long, which are given evaluation points of 0.5, 1, and 1.5, respectively. A, B, and C representing the work easiness are scored at 10, 20, and 30 points, respectively. The complexity evaluation point for each work element is calculated as a product of the evaluation point of the work time and the evaluation point of the work easiness. At this time, when the work element is repeatedly executed (work element No. 2 to 4), the number of repetitions is further multiplied. The complexity evaluation point for the entire process is calculated as a sum of the complexity evaluation points for work elements. A calculation method of the evaluation point and a scoring method described herein are examples.

Complexity evaluation of the maintenance process S02 obtained in the same manner is shown in FIG. 5B. In this example, the complexity evaluation point of the device disassembling process S01 is 355 points, and a complexity evaluation point of the maintenance process S02 is 40 points. Based on the complexity evaluation points, the device disassembling process S01 can be evaluated as a process more complicated than the maintenance process S02.

When the number of samples from which the measurement data is acquired increases, the work time is averaged. Therefore, by increasing the number of samples, precision of the work time gradually improves, and accuracy of the complexity evaluation can be improved.

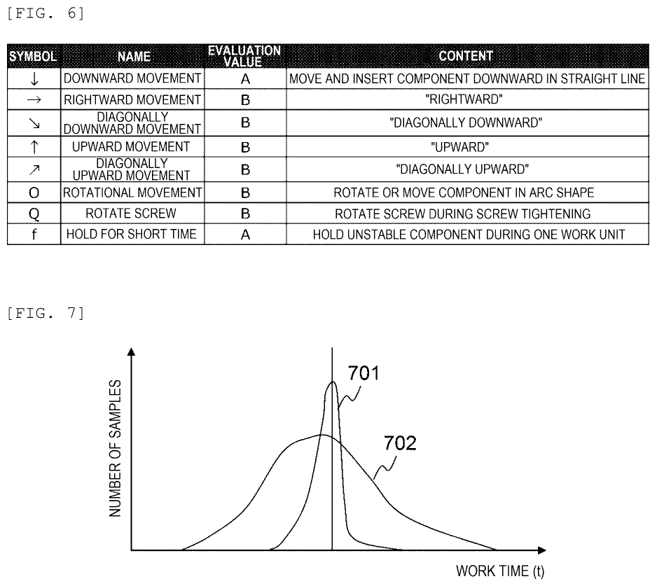

Next, the dexterity evaluation of the work will be described. The dexterity is evaluated using an index that changes depending on proficiency of a worker. For example, it is considered that the variation in work time of the work element is an effective index. FIG. 7 shows a histogram 701 for a work time of a work element A and a histogram 702 for a work time of a work element B. From the histogram 701, it can be determined that work element A is a work that has little variation among workers and is not greatly affected by proficiency, experience, or knowledge of the worker, and from histogram 702, it can be determined that the work element B is a work that varies greatly among workers and is strongly affected by proficiency, experience, and knowledge of the worker. A degree of variation in work time can be quantitatively understood, for example, by calculating a variance of a histogram.

Here, in addition to the variation in work time, a variation in operation and the work success rate are added as indexes of the dexterity evaluation. The variation in operation is a direct evaluation of the operation of the worker, motion of a line of sight, or the like. In the case of the skilled worker, a work operation is an effective operation without extravagance. For example, it is conceivable to monitor motion of a skilled worker to identify ideal work operation and then evaluate a deviation from the ideal work operation. When most of the sampled measurement data indicates approximations to the ideal work operation, the variation in operation can be evaluated to be small, and when the sampled measurement data includes a large amount of measurement data that deviates from the ideal work operation, the variation in operation can be evaluated to be large. For example, based on work video data and three-dimensional distance measurement data measured by an RGBD camera, a spatial positional relationship between a trajectory of the ideal work operation and a trajectory of measured work operation of a worker is compared to calculate a deviation rate from the ideal work operation, or a contact time with a component which is a work target, a head direction and a gazing point of a line of sight during the work that can be obtained from HMD worn by the worker, and the like are compared with those of the ideal work operation, and thus it is possible to evaluate the deviation from the ideal work operation. Further, the work success rate is calculated by determining a ratio of the number of successes to the number of execution of the work element, when a case in which a problem is found in the work in a subsequent process and rework is required is regard as a failure.

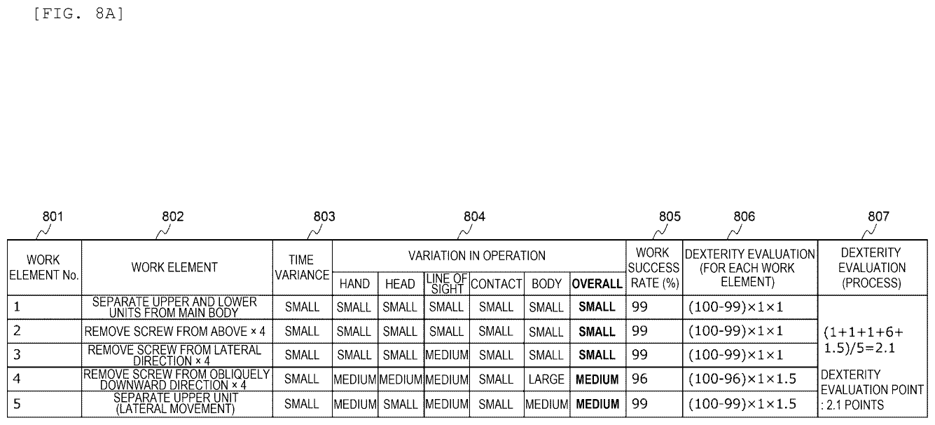

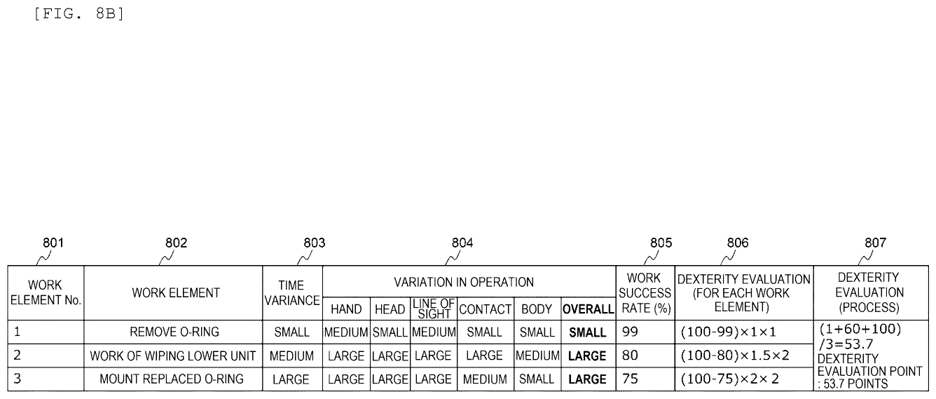

Dexterity evaluation of the device disassembling process S01 is shown in FIG. 8A. A work element number 801 is a number that specifies the work element in the process to be analyzed, and a work element 802 indicates a content of the work element in the process. A time variance 803 is a variation in work time required for executing the work element, and is a variance of the work time measured from the measurement data. Here, this is not a value, and is shown as, for example, three categories, for example, small, medium, and large. A variation in operation 804 indicates a variation described above for each element of the body, line of sight, or the like. These can also be quantitatively calculated as variances from the histogram, but there are also not shown as values, but rather as three categories, for example, small, medium, and large. Further, evaluation results of the variations in element operation obtained from the measurement data are combined to obtain an overall variation in operation. A work success rate 805 indicates the work success rate described above. A dexterity evaluation (for each work element) 806 indicates a dexterity evaluation point for each work element, and a dexterity evaluation (process) 807 indicates a dexterity evaluation point of the entire process.

In this example, the dexterity evaluation point for each work element is quantitatively calculated using the time variance, the variation in operation (overall), and the work success rate as indexes. Here, each of the time variance and the variation in operation is classified as small, medium, and large, which are given evaluation points of 1, 1.5, and 2, respectively, and the dexterity evaluation point for each work element is calculated as a product of (100-work success rate [%]), the evaluation point for the time variance, and the evaluation point for the variation in operation (overall). The dexterity evaluation point of the entire process is obtained as an average value of the dexterity evaluation points for the work elements. A calculation method of the evaluation point and a scoring method described herein are examples. Here, an example has been shown in which the dexterity is evaluated for work element units, but the dexterity may be evaluated on a set of operations as a unit, and for example, the dexterity may be evaluated on a plurality of work elements executed in succession as one unit.

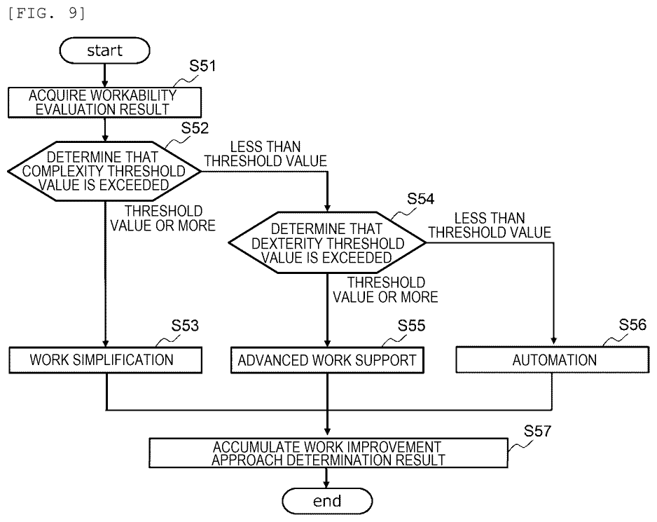

The work improvement approach determination unit 222 determines in what direction the work in the process is to be improved, using the complexity evaluation and the dexterity evaluation performed for each process by the workability evaluation unit 221. FIG. 9 shows a determination flow executed by the work improvement approach determination unit 222.

First, a workability evaluation result is acquired (S51). In the above-described example, a complexity evaluation result illustrated in FIG. 5A and a dexterity evaluation result illustrated in FIG. 8A are acquired in the device disassembling process S01, and a complexity evaluation result illustrated in FIG. 5B and a dexterity evaluation result illustrated in FIG. 8B are acquired in the maintenance process S02.

Next, the complexity evaluation result is compared with a predetermined threshold value (S52). If the complexity evaluation point is equal to or more than the threshold value, “work simplification” is determined as a work improvement approach (S53). For example, if the threshold value is set to 250 points, the complexity evaluation point (355 points) of the device disassembling process S01 is equal to or more than the threshold value, and thus the work improvement approach is determined to be the “work simplification”. On the other hand, the complexity evaluation point (40 points) of the maintenance process S02 is less than the threshold value. The process that is determined to require the “work simplification” can be said to be an excessively complicated and redundant work process, and thus first of all, such a process is simplified.

In the case in which the complexity evaluation point is less than the threshold value, the dexterity evaluation result is compared with a predetermined threshold value (S54). If the dexterity evaluation point is equal to or more than the threshold value, “advanced work support” is determined as the work improvement approach (S55). For example, if the threshold value is set to 40 points, the dexterity evaluation point (53.7 points) of the maintenance process S02 is equal to or more than the threshold value, and thus the work improvement approach is determined to be the “advanced work support”. The process determined to require “advanced work support” is a simplified work process in which complexity is low but dexterity is high, whereby it is difficult to automate the process using robots and the like. Therefore, by advancing work support by, for example, AR/VR, it is effective to create mechanisms to compensate for lack of the proficiency of the worker.

If the dexterity evaluation point is less than the threshold value, “automation” is determined as the work improvement approach (S56). A process determined to require “automation” has low complexity and is simplified and has low dexterity, and thus it is effective to reduce human work by using robots and the like.

A work improvement approach determination result for each process as described above is accumulated in the storage device 203 of the work analysis device 140 (S57). As described above, in this embodiment, by evaluating the process from the viewpoint of the complexity and the dexterity, not only is the work efficiency of the process in the related art improved, but by reviewing the processes themselves, the work can also be optimized. Further, in addition to the determination of the work improvement approach, it is desirable to make an improvement proposal in line with the determined approach.

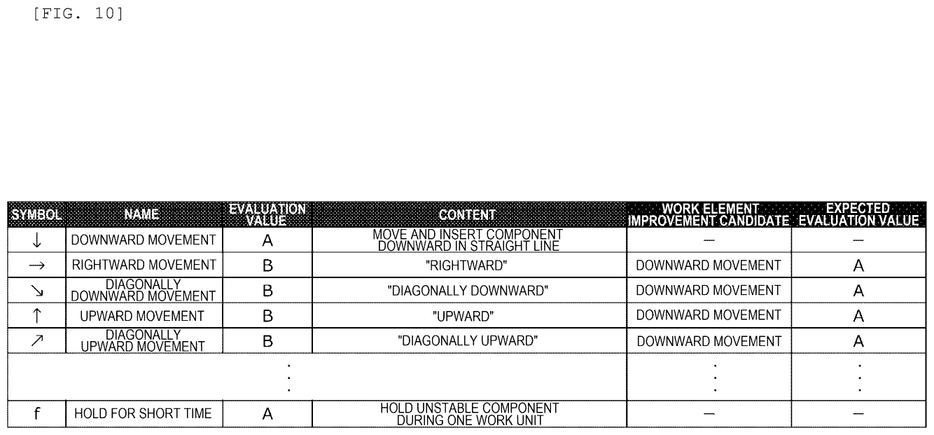

First, the process that is determined to require the “work simplification” is a process that is evaluated as being excessively complicated and redundant. By replacing a work element having a high evaluation value with a work element having a low evaluation value, the complexity evaluation value of the process can be reduced. FIG. 10 shows an example of a work element conversion table. The work element conversion table is obtained by adding information of a work element that is an improvement candidate to a work element having a high evaluation value in the work easiness evaluation table shown in FIG. 6. In the example of FIG. 10, work elements that are improvement candidates and evaluation values for the improvement candidates are added. The work improvement approach determination unit 222 uses the work element conversion table to replace the work element having the high evaluation value in the process determined to require “work simplification” with the work element having a lower evaluation value, thereby creating a process improvement proposal, calculates the complexity evaluation value improved in this case, and stores the calculated complexity evaluation value together with a determination result.

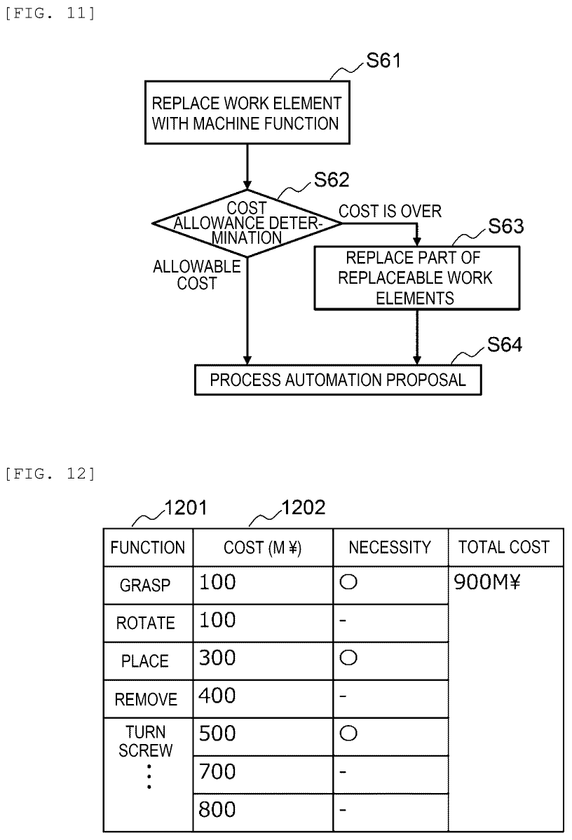

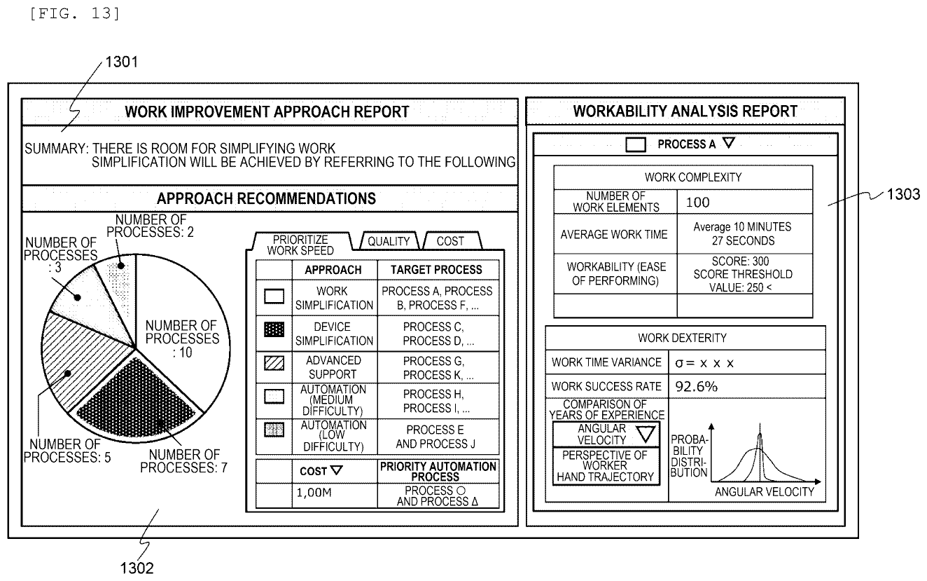

The process determined to require “automation” is a process evaluated as being effective in reducing the human work. However, since replacing the human with a robot involves a cost for mechanization, it is preferable to present a work improvement proposal after evaluating the cost. FIG. 11 shows an automation proposal creation flow of a process performed by the work improvement approach determination unit 222. First, work elements in the process is replaced with a machine function (S61). For this purpose, a machine function conversion table shown in FIG. 12 is used. In the machine function conversion table, a function 1201 to be mechanized and a cost 1202 required for mechanizing the function are registered. In step S61, a cost is calculated assuming that all work elements in the process that can be mechanized are mechanized. Next, it is determined whether the calculated cost is within an allowable range of a user (S62). An upper limit of a cost allowed for automation may be set in advance by a user, or the calculated cost may be displayed on GUI and the user may be prompted to accept or reject the calculated cost and, if reject, to input the upper limit of the cost. When the cost falls within the allowable range, a content created in step S61 is set as a process automation proposal (S64). On the other hand, when the cost is over, the process automation proposal in which a part of the work elements that can be replaced with the machine function is replaced with the machine function is created so that the cost is within the allowable cost (S63, S64).

The flow in FIG. 9 is an example, and various modifications are possible. For example, the determination of the “advanced work support” is made based on the evaluation of only the workability, but the determination of the “advanced work support” may be made after the cost evaluation. Alternatively, the determination of the “work simplification” is made based on the complexity evaluation, but it is also possible to allow the user to select the “device simplification”. The device simplification is an approach of simplifying the process by changing a structure of a device or a product (in this example, a semiconductor manufacturing device) as the work target, and the “work simplification” may be selected when the user does not select the “device simplification”.

The work improvement approach display generation unit 223 summarizes analysis results for the work described above, and displays the analysis results as a work analysis report via the analysis result output unit 225. FIG. 13 shows an example of a work analysis report display screen. A summary of the analysis results is displayed in a summary 1301. An improvement approach display unit 1302 displays a summary of an improvement approach determined for the work analyzed by the measurement data analysis unit 220. The number of cases for each improvement approach, a specific target process, a cost, and the like are displayed. A workability analysis report 1303 displays the analysis result of the workability that is the basis for determining an analytical approach for the selected process. In the example of FIG. 13, the workability analysis report is displayed on a process A determined to require the “work simplification”. The user checks this content and makes improvement to the work.

Depending on a position or a role of a person viewing this screen, control may be performed to modify or limit the display of some of the content. For example, the display shown in FIG. 13 is an example of a display presented to a user whose role is to promote work improvement, which is an original purpose. However, when a display is presented to a user whose role is to provide work training to a worker or to the worker himself/herself, it is advisable to extract and present data of the worker A, who is a subject of training, along with an overall distribution of the workability analysis report 1303. Accordingly, for example, it is possible to evaluate and check a degree of dexterity of the worker A in the entire process. This type of presentation has a secondary effect of being useful for training a worker on a work thereof.

The above-described embodiments and modifications have been described in detail to facilitate understanding of the invention, and the invention is not necessarily limited to those including all the configurations described above. A part of the configuration of one embodiment and modification can be replaced with the configuration of another embodiment and modification, and the configuration of another embodiment and modification can be added to the configuration of one embodiment and modification. A part of a configuration in each of the embodiment and the modification may be added to, deleted from, or replaced with another configuration.

### Reference Signs List

100: semiconductor manufacturing device
101, 102: camera
103: HMD
104: worn work sensor
105: glove type sensor
106: 360° camera
110: measurement data collection device
120: measurement data accumulation unit
130: network
140: work analysis device
201: processor (CPU)
202: memory
203: storage device
204: input interface
205: output interface
206: communication interface
207: bus
208: input device
209: display device
210: work measurement unit
220: measurement data analysis unit
221: workability evaluation unit
222: work improvement approach determination unit
223: work improvement approach display generation unit
225: analysis result output unit
401: main body
402: upper unit
403: lower unit
405, 406: O-ring
501: work element number
502: work element
503: work time
504: work easiness
505: complexity evaluation (for each work element)
506: complexity evaluation (process)
701, 702: histogram
801: work element number
802: work element
803: time variance
804: variation in operation
805: work success rate
806: dexterity evaluation (for each work element)
807: dexterity evaluation (process)
1201: function
1202: cost
1301: summary
1302: improvement approach display unit
1303: workability analysis report

1. A work analysis system comprising:
a work measurement unit configured to collect measurement data from a sensor that measures an operation of a worker in a predetermined work;
a measurement data accumulation unit configured to accumulate the measurement data collected by the work measurement unit; and
a measurement data analysis unit configured to analyze the predetermined work based on the measurement data accumulated in the measurement data accumulation unit, wherein
the measurement data analysis unit includes a workability evaluation unit configured to evaluate workability of the predetermined work based on the measurement data accumulated in the measurement data accumulation unit, and a work improvement approach determination unit configured to determine a work improvement approach of the predetermined work based on the workability of the predetermined work evaluated by the workability evaluation unit.

2. The work analysis system according to claim 1, wherein
the workability evaluation unit evaluates complexity, which indicates a degree of complexity of the predetermined work, and dexterity, which indicates an experience level and a degree of knowledge required to perform the predetermined work, as the workability of the predetermined work.

3. The work analysis system according to claim 2, wherein
as the work improvement approach, the work improvement approach determination unit selects simplification of a work or simplification of a predetermined device when the predetermined work is a work that targets the predetermined device in a case in which the predetermined work is determined to be high in complexity, selects advanced work support to advance support for the worker in a case in which the predetermined work is determined to be low in complexity and high in dexterity, and selects automation in which a work of the worker is replaced with a machine function in a case in which the predetermined work is determined to be low in complexity and dexterity.

4. The work analysis system according to claim 2, wherein
the measurement data analysis unit divides the measurement data for a plurality of processes based on video data obtained by capturing an image of a situation of the predetermined work with a camera, and analyzes the predetermined work for each process.

5. The work analysis system according to claim 4, wherein
the workability evaluation unit disassembles the operation of the worker in each of the processes into work elements, performs a complexity evaluation on each of the work elements based on a work time required for the work element and work easiness of the work element, and integrates the complexity evaluations for the work elements in the process to perform a complexity evaluation on the process.

6. The work analysis system according to claim 4, wherein
the workability evaluation unit performs a dexterity evaluation for each set of operations of the worker in each of the processes, based on a variation in work time, a variation in operation, and a work success rate, and integrates the dexterity evaluations for the sets of operations of the worker in the process to perform a dexterity evaluation on the process.

7. The work analysis system according to claim 3, wherein
the work improvement approach determination unit creates a work improvement proposal in which a work element in the predetermined work is replaced with a work element having lower complexity when the simplification of the work is selected as the work improvement approach.

8. The work analysis system according to claim 3, wherein
the work improvement approach determination unit creates a work improvement proposal in which a work element in the predetermined work is replaced with the machine function when the automation is selected as the work improvement approach.

9. The work analysis system according to claim 8, wherein
the work improvement approach determination unit creates a work improvement proposal in which a part of the work element in the predetermined work is replaced with the machine function to satisfy a specified cost upper limit when the automation is selected as the work improvement approach.

10. The work analysis system according to claim 1, wherein the predetermined work is a maintenance work for a semiconductor manufacturing device.

11. A work analysis method using a work analysis system,
the work analysis system including a work measurement unit, a measurement data accumulation unit, and a measurement data analysis unit,
the work analysis method comprising:
collecting, by the work measurement unit, measurement data from a sensor that measures an operation of a worker in a predetermined work;
accumulating, by the measurement data accumulation unit, the measurement data collected by the work measurement unit; and
by the measurement data analysis unit, evaluating workability of the predetermined work based on the measurement data accumulated in the measurement data accumulation unit, and determining a work improvement approach of the predetermined work based on the workability of the predetermined work.

12. The work analysis method according to claim 11, wherein
the measurement data analysis unit evaluates complexity, which indicates a degree of complexity of the predetermined work, and dexterity, which indicates an experience level and a degree of knowledge required to perform the predetermined work, as the workability of the predetermined work.

13. The work analysis method according to claim 12, wherein
as the work improvement approach, the measurement data analysis unit selects simplification of a work or simplification of a predetermined device when the predetermined work is a work that targets the predetermined device in a case in which the predetermined work is determined to be high in complexity, selects advanced work support to advance support for the worker in a case in which the predetermined work is determined to be low in complexity and high in dexterity, and selects automation in which a work of the worker is replaced with a machine function in a case in which the predetermined work is determined to be low in complexity and dexterity.
